(19) United States
(12) Patent Application Publication
(10) Pub. No.: US 2023/0127964 A1
(43) Pub. Date: Apr. 27, 2023

(54) METHOD FOR DEFATTING WHEY PROTEIN CONCENTRATE AND PRODUCING WHEY PROTEIN ISOLATE

(71) Applicant: GLANBIA NUTRITIONALS LIMITED, Kilkewnney (IE)

(72) Inventors: Stephen J. Adolphson, Twin Falls, ID (US); Loren S. Ward, Twin Falls, ID (US)

(21) Appl. No.: 17/947,943

(22) Filed: Sep. 19, 2022

Related U.S. Application Data
(63) Continuation of application No. 15/338,439, filed on Oct. 30, 2016, now abandoned.
(60) Provisional application No. 62/249,121, filed on Oct. 30, 2015.

(51) Int. Cl. A23J 1/20; A23J 3/08; A23L 5/20

(52) U.S. Cl. CPC A23J 1/205; A23J 3/08; A23L 5/23; A23V 2002/00

(57) ABSTRACT

Disclosed is a method for extracting fat from whey protein concentrate. The method also extracts lactose from whey protein concentrate. Whey protein isolate can be produced from whey protein concentrate, high-fat whey protein concentrate, or both, using the method of the invention.

### FIELD OF THE INVENTION

The invention relates to a method for removing lipids/fat from whey protein concentrate, as well as to a method for producing whey protein isolate from whey protein concentrate.

### BACKGROUND OF THE INVENTION

Bovine whey, contains approximately 1% protein. It is separated from milk during cheese processing and is concentrated to make whey protein concentrates (WPC) or whey protein isolates (WPI). WPC is generally considered to contain protein in the range of from about 35 to about 80%. Some sources indicate that a product is still a WPC if the protein content goes as high as 89%, but in practice it is difficult to achieve levels higher than about 80% when the retentate contains as much fat as is commonly found in WPCs. The higher protein products from which almost all the fat has been removed are referred to as whey protein “isolates” (WPIs). The term “concentrate” refers to the fact that the protein level of WPC is significantly higher than that of the whey from which it was derived, and it contains other components, such as lactose and fat. The term “isolate” refers to the fact that the protein level of WPI is significantly higher than that of a concentrate, and the protein has also been isolated so that there is very little remaining lactose, fat, etc. Whey proteins include β-lactoglobulin (β-LG), a-lactalbumin (a-LA), glycomacropeptide (if made from sweet whey), immunoglobulins, lactoferrin, and bovine serum albumin. Casein and fragmented casein residues, as well as minor whey proteins (e.g., lactoferrin, lactoperoxidase, growth factors, etc.) are also present in small quantities.

Filtration traditionally has been used in the dairy industry for removing bacteria, defatting whey, and enriching casein (micellar casein) in cheese-making. Filtration is also used for the fractionation of caseins and whey proteins from milk, since most caseins in milk are found in casein micelles that are large, spherical, stable complexes of casein which are larger in molecular weight than whey proteins because whey proteins have limited self-association characteristics in milk, and therefore tend not to form aggregates. The larger molecules that are retained in the membrane are referred to as the “retentate,” and the smaller molecules that pass through the membrane are referred to as the “permeate.”

Microfiltration is one of the methods by which whey protein isolate is manufactured. Microfiltration retains fat found in the whey while allowing the whey protein, lactose and some minerals to pass into the permeate. The permeate is further filtered using ultrafiltration to remove lactose and some of the minerals, to obtain a finished product that has >90% protein on a dry matter basis and less than 1% fat on a dry matter basis.

Ultrafiltration, developed in the late 1970’s, is often used to convert whey to whey protein concentrates. Whey protein concentrate 80 (containing 80% protein on a dry matter basis) is manufactured by extensive ultrafiltration and diafiltration of crude whey to reduce the non-protein components, especially the lactose content. According to the U.S. Dairy Export Council, commercial whey protein concentrate 80 (WPC80) typically contains about 80 to 82% protein, 4 to 8% lactose, 3 to 4% ash, 3.5 to 4.5% moisture, and 4 to 8% fat, while whey protein isolate typically contains 90.0%-92.0% protein, 0.5%-1.0% lactose, 0.5%-1.0% fat, 2.0%-3.0% ash, and 4.5% moisture (Reference Manual for U.S. Whey and Lactose Products, USDEC (2008), p. 33). Typical compositions of WPCs of varying protein levels produced are shown in Table 1.

TABLE 1

| | | | | |
|---|---|---|---|---|
| Protein in dry matter | 35 | 50 | 65 | 80 |
| Moisture | 4.6 | 4.3 | 4.2 | 4.0 |
| Crude Protein | 36.2 | 52.1 | 63.0 | 81.0 |
| True Protein | 29.7 | 40.9 | 59.4 | 75.0 |
| Lactose | 46.5 | 30.9 | 21.1 | 3.5 |
| Fat | 2.1 | 3.7 | 5.6 | 7.2 |
| Ash | 7.8 | 6.4 | 3.9 | 3.1 |
| Lactic Acid | 2.8 | 2.6 | 2.2 | 1.2 |

To produce WPC80 concentrate, liquid whey is first concentrated 20x to 30x by ultrafiltration, giving a solids content of about 25%. Raw whey may also be concentrated using reverse osmosis to increase the solids concentration, then using ultrafiltration to further purify those solids. The concentrate is then processed by diafiltration (adding water to the feed during filtration) to wash out lactose and ash (minerals).

Another way by which whey protein concentrate may be made is by using the retentate from whey protein isolate manufacturing. The microfiltration process produces a permeate, containing the defatted whey protein (WPI), and a retentate which contains milk fat globule membranes (MFGM), residual fat, mineral, lactose and residual protein that did not permeate through during microfiltration. The WPI (MF permeate) undergoes further processing to concentrate the protein, and is then spray-dried before packaging. The retentate may also be further ultrafiltered to remove lactose and some minerals and then dried, producing a high-fat WPC powder (HFWPC). It should also be noted that unlike the protein in the WPC product, which is collected as a retentate using a membrane that is selected to retain the protein, the protein that remains with the HFWPC product is collected in the retentate using a membrane that is selected to allow the protein to pass through in the permeate. The HFWPC protein must therefore have certain properties that distinguishes it from the WPC protein. The WPC and HFWPC products therefore differ in both the fat content and the protein in the products.

Milk fat triglycerides form globules. The globules are surrounded by a protein and phospholipid membrane (the milk fat globule membrane) that stabilizes the globules in the serum (water) phase of milk. The residual lipid fraction in both WPC and HFWPC comes from fragments of milk fat globule membrane (MFGM) and very tiny intact fat globules. These small, stable colloidal particles remain in the whey after clarification. The MFGM fragments are further concentrated and retained with the protein during manufacture of both WPC80 and HFWPC80.

The increased protein concentration, decreased fat content, and decreased lactose content of WPI has made it a very desirable product for use in performance nutrition and other products which utilize whey protein as a key ingredient. The price per pound for whey protein isolate is significantly higher than that for whey protein concentrate. In 2015, for example, it varied from about 50 to about 100% higher, with the price over time becoming more pronounced. Defatted protein and defatted protein hydrolysate are more attractive options for many of the uses for whey protein, in part because the reduction in fat causes a concomitant reduction in cholesterol.

Whey protein hydrolysates (WPH) generally command an even higher price than does WPI. WPH can be produced from WPC, but the higher fat content of HFWPCs have made them a “lower quality” product from which hydrolysates are not generally made because, being a byproduct of microfiltration to separate fat and protein, they have already been through a filtration process that separates protein from fat-the protein of HFWPC being the fraction of the protein that remained with the fat. The protein a HFWPC contains could, if isolated from the MFGM and fat, be both nutritionally and commercially valuable. Furthermore, if sufficiently isolated, the MFGM may itself be a valuable product, as a variety of beneficial physiological effects have been associated with MFGM. It would therefore provide a significant advantage in the industry if methods were developed for utilizing HFWPC as a source of WPC, WPI, and/or WPH.

### SUMMARY OF THE INVENTION

The invention relates to a method for removing fat from whey protein concentrate, the method comprising the steps of (a) agglomerating particles of whey protein concentrate to produce whey protein agglomerates that readily submerge when admixed with ethanol; (b) admixing the whey protein agglomerates with ethanol in a ratio of from about 1:3 to about 1:5 to immerse the whey protein agglomerates in ethanol for a period of at least about 30 minutes; and (c) separating the defatted solids from the ethanol.

In various aspects of the invention, the method may also comprise the steps of collecting the micella formed by the ethanol and fat. The step of admixing the whey protein agglomerates with ethanol can comprise admixing the whey protein agglomerates into a container comprising ethanol. The step of admixing the whey protein particles with ethanol can comprise feeding the whey protein particles into a stream of ethanol in a series of extraction chambers, or extraction stages. The step of admixing the whey protein agglomerates into a container comprising ethanol can comprise feeding the whey protein agglomerates into a countercurrent extractor. The step of admixing the whey protein agglomerates into a container comprising ethanol can comprise feeding the whey protein particles into an immersion-type extractor containing ethanol. In various aspects, the ethanol can be heated to a temperature of from about 100° F. to about 135° F.

In various aspects, the protein starting material can comprise whey protein concentrate, denatured WPC, evaporated WPC, or other higher-fat product such as those associated with whey processing by microfiltration, ultrafiltration, or ionexchange. The whey protein concentrate can therefore be selected from the group consisting of whey protein concentrate, denatured whey protein concentrate, evaporated whey protein concentrate, high fat whey protein concentrate, and combinations thereof.

The invention relates to a method for producing whey protein isolate from whey protein concentrate, the method comprising the steps of (a) agglomerating particles of whey protein concentrate to produce whey protein agglomerates that readily submerge when admixed with ethanol; (b) admixing the whey protein agglomerates with ethanol in a ratio of from about 1:3 to about 1:5 to immerse the whey protein agglomerates in ethanol for a period of at least about 30 minutes; and (c) separating the defatted solids from the ethanol.

### BRIEF DESCRIPTION OF THE DRAWINGS

FIG. 1, FIG. 2, and FIG. 3 are photographs illustrating the effect of agglomeration of whey protein concentrate particles on settlement of those particles after being poured into ethanol. Non-agglomerated WPC is shown on the left in each photo, and agglomerated WPC is shown on the right.

FIG. 4 is a flow chart illustrating one embodiment of a method of the invention for producing a whey protein isolate product from whey protein concentrate.

### DETAILED DESCRIPTION

The inventors have developed a method for removing fat from high-fat whey protein concentrates (HFWPCs) derived from the by-product retentate from the manufacture of whey protein isolates. The method may also be useful for the removal of fat from standard whey protein concentrates (WPC). As noted above, however, the removal of fat from the high-fat whey protein concentrates derived from WPI manufacture has been a particularly difficult problem to solve because there are significant distinctions between WPC derived directly from whey and HFWPC derived from WPI manufacture. The present method provides a solution that is cost-effective and produces a significantly higher-value product from the lower-value HFWPC. The method comprises agglomerating particles of whey protein concentrate to produce whey protein agglomerates that readily sink when admixed with ethanol, admixing the whey protein particles with ethanol in a ratio of from about 1:3 to about 1:5 (w/v) to immerse the whey protein agglomerates in ethanol for a period of at least about 30 minutes, and separating the defatted solids (comprising protein) from the ethanol. The method can also comprise, in various embodiments, combining agglomerated whey protein with ethanol, the agglomerated whey protein being of sufficient agglomerate size to sink in the ethanol and be immersed in the ethanol for a period of at least about 30 minutes, the agglomerated whey protein/ethanol ratio being from about 1:3 to about 1:5, and collecting the defatted solids from the ethanol.

The invention also provides a method by which whey protein isolate may be made from a whey protein concentrate starting material. Traditionally, ion exchange and/or microfiltration have been used in the dairy industry to produce whey protein isolate. The present invention provides a more cost-effective alternative to these methods, with advantages that include reducing water consumption, for example, as compared to microfiltration methods. The ethanol extraction method of the invention removes both fat and lactose from whey protein concentrate, providing a whey protein product that meets the industry standard for whey protein isolate. Whey protein isolate is a highly-valued product of whey processing, and the present invention provides a method by which it can be isolated, potential providing lower initial equipment costs, reducing water consumption during manufacturing, and streamlining processing steps. After ethanol extraction by the method of the invention, the inventors have demonstrated that a whey protein isolate containing 90.82% protein, 0.21% lactose, and 1.90% lipid can be produced (see Example 3 and Table 5). Whey protein isolate can be made by the method of the invention using either a WPC or HFWPC starting material (or both, if desired).

Extraction of fat from whey protein concentrate has previously been performed by a variety of methods, including the use of base or acid in combination with heat to dissociate the lipid-protein complexes, the use of binary solvent mixtures (e.g., chloroform-methanol, dichloromethane-methanol, hexane-isopropanol, etc.) and solid phase extraction (Vaghela, M.N. and A. Kilara. A Rapid Method for Extraction of Total Lipids from Whey Protein Concentrates and Separation of Lipid Classes with Solid Phase Extraction. J. Amer. Oil Chem. Soc. (1995) 72: 1117-1121). It should be apparent, however, that these methods have either limited application or may, due to the use of undesirable solvents for the processing of a food product, be of limited value to the industry as methods by which whey protein concentrates may be processed to remove fat.

In 1970, Morr and Lin disclosed a method for preparing an alcohol-precipitated whey protein concentrate (Morr, C.V. and S.H.C. Lin. Preparation and Properties of an Alcohol-Precipitated Whey Protein Concentrate. J. Dairy Sci. (1970) 53(9): 1162-1170). They compared the efficacy of a variety of alcohols, including ethanol, for preparing whey protein concentrates from whey, and for washing whey protein concentrates. However, as others have disclosed when describing various methods for whey protein concentrate processing, their method required centrifugation after the first extraction and again after the second extraction. Centrifugation is avoided in large-scale commercial processing if possible, because it increases equipment costs, increases the complexity of processing methods, and requires an effective means by which the pellet and supernatant may be collected. The present method does not require the use of centrifugation. Instead, it can be performed in an automated system comprising a series of ethanol extraction stages such as the immersion-type separation system of the Crown Iron works Model IV Extractor. In such a system, a series of ramps (stages) are sequentially connected so that the solids may be fed into the first stage and are submerged in ethanol. Fresh ethanol is introduced into the extractor at the opposite end of the feed material so that the solids are exposed to fresh ethanol directly prior to exiting the extractor. The HFWPC solids, having been agglomerated so that they readily sink in the ethanol, settle onto a ramp fitted with a series of paddles, which convey the solids along the ramp through the ethanol in a solid-liquid countercurrent-type extraction method. The solids are conveyed from one ramp and are deposited onto a subsequent ramp and are again conveyed along by paddles. The solids continue through a series of these stages while continuously being submerged in ethanol. After being conveyed through this series of stages, the solids are deposited into an external collection chamber or may be conveyed directly to suitable desolventization equipment.

Agglomerated protein powders may be produced by a variety of methods known to those of skill in the art, such as, for example, by spray-drying, then rewetting and agglomerating powders in fluidized beds. Whey protein powder can be fluidized on a bed by an upward hot air flow. A solvent binder, can then be sprayed onto the powder from above or inside the bed. The solvent binder can be water, steam, whey solution, or a solution of lecithin. The binder makes the particle sticky so that it will bind with other particles. Agglomeration can also be performed as the whey protein is spray-dried (i.e., single pass agglomeration), eliminating the need for additional processing steps to produce the agglomerate.

In various aspects of the invention, the method may also comprise the steps of collecting the micella formed by the ethanol and fat and removing the ethanol solvent to isolate the fat product, the milk fat globule membrane including its phospholipid-enriched subfractions. The step of admixing the whey protein agglomerates with ethanol can comprise admixing the whey protein agglomerates into a container comprising ethanol. The step of admixing the whey protein agglomerates with ethanol can comprise feeding the whey protein particles into a stream of ethanol in a countercurrent extractor. In various aspects, the ethanol can be heated to a temperature of from about 100° F. to about 135° F.

In various aspects, the protein starting material can comprise whey protein concentrate, denatured WPC, evaporated WPC, or other higher-fat product such as those associated with whey processing by microfiltration, ultrafiltration, or ionexchange (HFWPC).

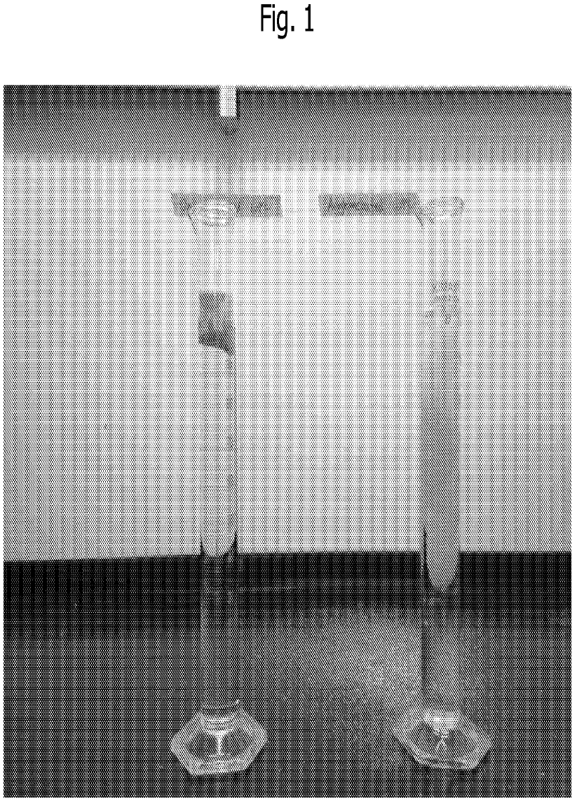

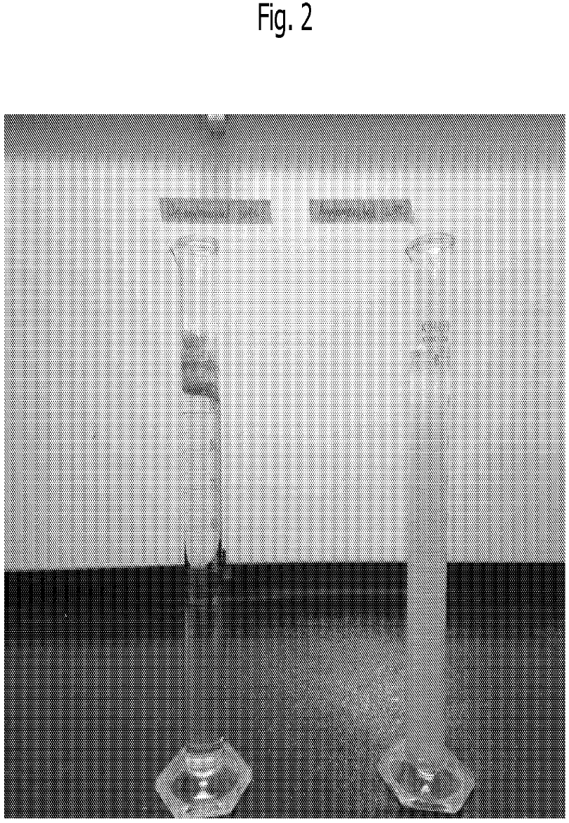

As used herein, the abbreviation “WPC” is intended to denote a whey protein concentrate that is produced by filtration of the whey fraction from milk. The abbreviation “HFWPC,” on the other hand, is intended to denote a whey protein concentrate that, although also originating in the whey fraction of milk, is produced by collecting the retentate from whey protein isolate processing, wherein the WPI is collected as the permeate. The two products, although both referred to as whey protein concentrates, differ significantly in fat content. “Fat” is intended to collectively refer to the fats, lipids, fatty acids, etc., retained in the whey protein concentrate after it is produced from the whey starting material. WPC contains valuable compounds within the “fat,” or lipid, fraction, including, for example, butyric acid and long chain fatty acids such as omega-3 and omega-6 fatty acids. The milk fat globule membrane component comprises a significant portion of this “fat,” which also comprises cholesterol. “Particles of whey protein concentrate,” as used herein, can comprise either HFWPC particles, WPC particles, or a combination of both. “Readily submerging” refers to the propensity of the agglomerated particles to sink in the ethanol, rather than floating on the surface of the liquid, and the contrast between these two particle behaviors is illustrated in FIGS. 1-3. Agglomerates that “readily submerge” do so without difficulty.

WPC proteins contain significant levels of proteins that, for the most part, can readily be separated from the MFGM and small fat globules, while HFWPC proteins are more challenging to separate using filtration and generally remain associated with the MFGM and fat globules after microfiltration. Onwulata et al. analyzed six commercial WPC80 products, finding that the particle sizes of those six products ranged from 53 microns to 382 microns. They also observed that smaller particle size correlated with lower fat. (Onwulata, C.I., et al. Minimizing Variations in Functionality of Whey Protein Concentrates from Different Sources, J. Dairy Sci. (2004) 87: 749-756.) The inventors have discovered that increasing the particle size aids in decreasing fat in (i.e., removal of the fat from) WPC, using an ethanol extraction comprising dispersing the WPC into the ethanol solvent. Generally, those of skill in the art would consider it beneficial to decrease particle size in order to increase surface area and exposure to solvent in the extraction process, but the inventors have determined that it is beneficial to increase particle size in order to promote extraction of fat and lactose from whey protein concentrate. Creating agglomerated whey protein concentrate particles also makes it possible to automate the extraction process, using immersion extraction equipment to perform the ethanol extraction process. To facilitate removing the fat and lactose from the WPC, and separately collecting the protein, WPC is agglomerated by means known to those of skill in the art to produce particles that readily settle, or sink, in the ethanol. As shown in FIGS. 1-3, HFWPC can be particularly difficult to disperse into ethanol. Agglomeration of the particles, as shown in FIGS. 1-3, where the un-agglomerated material is shown on the left and the agglomerated material is shown on the right, produces a significantly more ethanol-soluble material.

Ethanol extraction of fat from WPC by the method of the invention may be referred to as immersion-type extraction. Briefly, one method by which ethanol can be used to defat WPC in immersion-type extraction comprises the steps of agglomerating WPC (e.g., high-fat WPC) to produce a particle size that promotes settlement (i.e., sinking) of the WPC when WPC is added to ethanol in a first beaker, vat, or other type of container. Heating the ethanol to a temperature of from about 100° F. to about 135° F. optimizes the extraction process, as does adding the WPC to the ethanol at a 3:1 to 5:1 ethanol-to-solids ratio. The temperature is maintained for a period of about 30 minutes to about 120 minutes, with intermittent stirring. The oil/ethanol phase is then poured off into a second container and fresh ethanol (at a temperature of from about 100° F. to about 135° F. is added, stirring intermittently as in the previous step. These steps of admixing with ethanol (by the addition of ethanol to the first container) are repeated at time intervals. The ethanol is then carefully removed (e.g., poured off) and the residual solvent is evaporated. Suitable means for solvent evaporation include, for example, using a rotary evaporator or exposing the solids to steam for a period of time from about 1 to about 30 minutes.

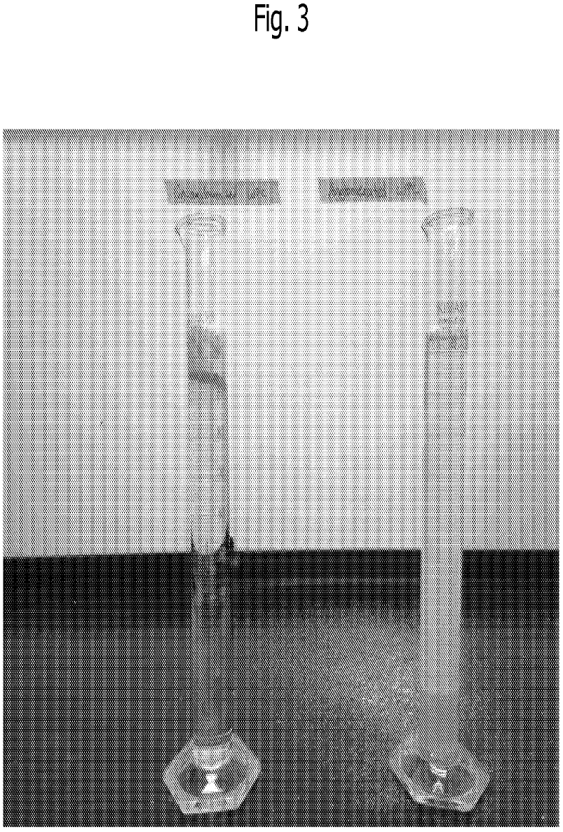

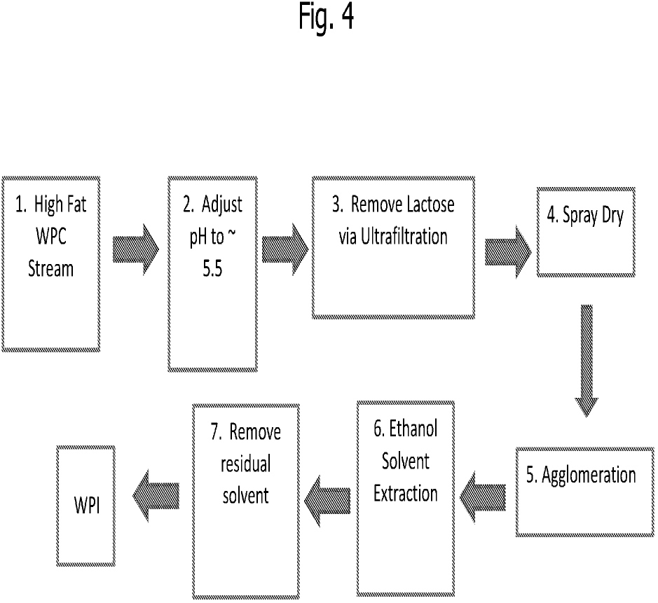

As shown in FIG. 4, the method of the invention also comprises a method for producing whey protein isolate products with protein levels above 90% on a dry matter basis. Membrane filtration (e.g., ultrafiltration, microfiltration) and pH adjustment can be used to lower the lactose and mineral content of a WPC stream. The treated WPC can then be dried, agglomerated, and further processed using the ethanol solvent extraction method disclosed herein to remove fat, resulting in a whey protein isolate product.

The method of the invention can also be used to remove lactose from whey protein concentrate. Ethanol extraction of lactose from non-fat dry milk has previously been described (Hoff, J.E. fet al. Ethanol Extraction of Lactose from Nonfat Dry Milk: Production of Protein Raffinate. J. Dairy Sci. (1987) 70:1785-1796). However, such methods typically require the use of processing equipment, methods, or steps that are not practical (e.g., not economically feasible) for large-scale commercial processing. Hoff et al., for example, utilize centrifugation to separate the protein and lactose, while the present method, utilizing agglomerated whey protein concentrate, makes it possible to readily separate those components to provide a raffinate (whey protein) and extract (ethanol/lactose) using more cost-effective mechanical means to accomplish the requisite immersion extraction. In the method of the invention, agglomerated WPC is admixed with ethanol in a ratio of from about 1:3 to about 1:5 to immerse the whey protein agglomerates in ethanol for a period of at least about 30 minutes; and the defatted solids are separated and collected from the ethanol, leaving the lactose in the ethanol solvent.

The invention also provides a method by which milk fat globule membrane, which is present at higher levels in HFWPC than in either WPC or WPI, can be isolated. In whole milk, the fat globules are surrounded by a protein and phospholipid membrane (the milk fat globule membrane) that stabilizes the globules in the serum phase of the milk. The residual lipid fraction in WPC80 and HFWPC80 comes from fragments of milk fat globule membrane (MFGM) and very tiny intact fat globules. These MFGM fragments and fat globules are generally not removable by centrifugation or other means by which the larger, intact fat globules may be removed. Filtration means, such as ultrafiltration, for example, provide a method by which the MFGM may be isolated. However, it should be apparent to one of skill in the art that the more protein that remains in the retentate following filtration of a whey protein concentrate starting material, the greater is the impurity level of the MFGM fraction that remains with the retentate-and the more closely associated the MFGM and remaining protein are likely to be, making them harder to separate by additional filtration means. Separation of the protein from the MFGM and associated tiny fat globules can be accomplished by the method of the invention, providing the additional advantage of removing cholesterol from the HFWPC-derived whey protein isolate.

The products produced by the method of the invention have nutritional and physiological importance. For example, whey protein contains calcium-binding peptides that can form complexes with calcium to improve its absorption and bioavailability (Huang, S.L. et al. Purification and characterisation of a glutamic acid-containing peptide with calcium-binding capacity from whey protein hydrolysate, J Dairy Res. 2015 Feb;82(1):29-35). Peptides derived from whey protein have inhibitory effects on angiotensin-I-converting enzyme (ACE) (Fitzgerald, R.J. and Meisel, H. Lactokinins: whey protein-derived ACE inhibitory peptides. Nahrung. 1999 Jun;43 (3):165-7. Whey protein hydrolysates, which may be produced from either WPC or WPI products made by the method of the invention, have been reported to be a good natural source of antioxidant peptides (Zhang, X.Q. et al. Isolation and identification of antioxidant peptides derived from whey protein enzymatic hydrolysate by consecutive chromatography and Q-TOF MS. J Dairy Res. 2013 Aug; 80(3):367-73.). Whey protein hydrolysates have been shown to be more effective for use in enteral diets than are free amino acids (Boza, J.J. et al. Protein hydrolysate vs free amino acid-based diets on the nutritional recovery of the starved rat. Eur J Nutr. 2000 Dec; 39(6):237-43). Dietary MFGM supplementation combined with regular exercise improves skeletal muscle strength (Soqa, S., et al. Dietary milk fat globule membrane supplementation combined with regular exercise improves skeletal muscle strength in healthy adults: a randomized double-blind, placebo-controlled, crossover trial. Nutr J. 2015 Aug 25;14(1): 85). Components of the milk fat globule membrane have been suggested to have anticancer benefits, cholesterol-lowering effects, and anti-bacterial effects (Spitzburg, V.L. Invited Review: Bovine Milk Fat Globule Membrane as a Potential Nutraceutical. J. Dairy Sci. 88:2289-2294). Results of at least one study indicate that MFGM supplementation to infant formula narrows the gap in cognitive development between breastfed and formula-fed infants (Timby, N., et al. Neurodevelopment, nutrition, and growth until 12 mo of age in infants fed a low-energy, low-protein formula supplemented with bovine milk fat globule membranes: a randomized controlled trial. Am J Clin Nutr. 2014 Apr; 99(4):860-8).

Products made by the method of the invention can be used as supplements or as ingredients for supplements, ingredients for food and drink formulations, etc., such as, for example, nutritional bars, beverages, medical foods, infant formulas, and bakery products. Powdered products may be made by drying the protein using methods such as, for example, spray-drying, evaporation, freeze-drying, or other drying techniques known to those skilled in the art of producing protein powders.

The invention may be further described by the following non-limiting examples.

### EXAMPLES

### Example 1 - Automated Method for Ethanol Extraction

Ethanol extraction was performed using equipment located at, and provided by, Crown Iron Works (Roseville, Minnesota USA). Avonlac® 582 (Glanbia Nutritionals Inc., Twin Falls, Idaho) was used as the high-fat whey protein concentrate (HFWPC) starting material. Avonlac® 582 is an agglomerated HFWPC product that readily sinks when poured into ethanol (i.e., admixed with ethanol).

Feed material, comprising Avonlac® 582, was introduced into a stream of hot ethanol in a Crown Iron Works Model IV extractor (immersion-type extractor). The ethanol/HFWPC admixture was moved by paddles along a series of belts, the HFWPC remaining submerged in the ethanol during this process. Ethanol flowed countercurrent to the path of the solids. Defatted solids were conveyed up a ramp and collected at one end of the extractor, while the ethanol/oil miscella was collected at the opposite end.

Extractions were performed in four different trial runs, based on the residence time inside the extractor and the solvent-to-feed ratio, as shown below in Table 2:

TABLE 2

| Time | Solvent-to-Feed Ratio |
|---|---|
| 30 minutes | 3:1 |
| 60 minutes | 3:1 |
| 90 minutes | 3:1 |
| 90 minutes | 5:1 |

In full operation the defatted solids would be conveyed directly to a desolventizer to flash off any residual ethanol. In this trial, solids were spread into a thin layer and air-dried overnight, then placed in a desolventizer oven for 45 minutes at 160° F. with a rotating sweeping arm to agitate and stir the solids.

The oil/ethanol miscella was collected from all trials as a composite sample in a large tank. Ethanol was desolventized and the remaining oil was collected in a bucket.

Analytical results are shown below in Table 3. Fat and cholesterol levels were significantly decreased (as much as 76% and 85%, respectively). Extracted oil was not separated with each trial and was collected together as a composite sample.

Decantation methods probably contributed to the small level of protein that remained in the extracted oil. The solvent (and any protein carried with it) was then poured into the solvent/oil miscella tank for evaporation.

TABLE 3

| Sample | % Moisture* | Lactose | Protein (dwb) | Ash | Lipids | Cholesterol (mg/100 g) | pH |
|---|---|---|---|---|---|---|---|
| Control –Avonlac 582 | 5.67 | 1.75 | 79.4 | 3.67 | 9.83 | 415.4 | 6.31 |
| 30 min; 3:1 | 10.56 | 0.21 | 83.9 | 3.37 | 5.25 | 181.7 | 6.22 |
| 60 min; 3:1 | 11.37 | 0.17 | 84.8 | 3.32 | 3.34 | 109.4 | 6.22 |
| 90 min; 3:1 | 16.85 | 0.36 | 85.7 | 3.12 | 2.84 | 88.4 | 6.22 |
| 90 min; 5:1 | 15.73 | 0.35 | 85.5 | 3.23 | 2.30 | 62.7 | 6.26 |
| Extracted oil | 65.96 | 0.27 | 5.12 | 2.22 | 47.74 | -- | -- |

*- Elevated moisture levels are due to residual ethanol detected as water during the moisture test. Proper solvent removal using an efficient desolventizer system would reduce moisture levels to reflect levels closer to that of the control.

### Example 2

Avonlac® 582 (agglomerated whey protein concentrate product, Glanbia Nutritionals, Twin Falls, Idaho USA) was used in a benchtop method to remove fat from the whey protein concentrate. Avonlac® 582 was added to ethanol that had been preheated to 51° C. in a first container, and the contents of the container were stirred intermittently (30 second stirring, at 5-minute intervals). After 30 minutes, the oil/ethanol phase was poured off into a collection beaker and fresh hot ethanol was added to the first container. Intermittent stirring was again performed, followed by decantation of the oil/ethanol phase as before, and addition of fresh hot ethanol at the 60- and 90-minute time points. After 90 minutes, the solids were allowed to settle in the fresh ethanol for about 15 minutes, and the ethanol was poured off. Residual solvent was evaporated from the remaining whey protein using a rotary evaporator, or the material was left in a solvent hood for 72 hours to evaporate the ethanol. Results are shown below in Table 4.

TABLE 4

| Sample | % Moisture | % Lactose | % Protein (dmb) | % Ash | % Lipids |
|---|---|---|---|---|---|
| Untreated WPC Control | 5.67 | 1.75 | 79.4 | 3.67 | 9.83 |
| Treated WPC* | 6.32 | 1.16 | 87.34 | 3.48 | 1.94 |

* _“Treated” WPC is WPC that has been defatted using the ethanol extraction method of the invention.

### Example 3 - Production of WPI From HFWPC

HFWPC was pre-treated by lowering the pH to 5.5 to reduce mineral content, subjected to ultrafiltration to reduce lactose. The product was then dried and agglomerated. Extraction, according to the method described above in Example 2, was performed on the HFWPC that had been pre-treated (“Extracted WPC” in Table 5 below). Control WPC was not subjected to solvent extraction. Results are shown in Table 5, which illustrates that a product that contains the requisite percentage of protein to be qualified as a whey protein isolate, along with minimal fat, was produced by the method of the invention. As discussed above in this disclosure, the difference between the commercial value of the starting material and the WPI produced from it using the method of the invention is several dollars per pound.

TABLE 5

| Sample | % Moisture | % Lactose | % Protein (dmb) | % Ash | % Lipids |
|---|---|---|---|---|---|
| Control WPC | 12.17 | 0.48 | 81.76 | 2.46 | 10.38 |
| Extracted WPC | 10.16 | 0.21 | 90.82 | 2.42 | 1.90 |

1. A method for removing fat from whey protein concentrate to produce a defatted solids fraction comprising whey protein, the method comprising the steps of
(a) agglomerating particles of whey protein concentrate to produce whey protein agglomerates that readily submerge when admixed with ethanol;
(b) admixing the whey protein agglomerates with ethanol in a ratio of from about 1:3 to about 1:5 to immerse the whey protein agglomerates in ethanol for a period of at least about 30 minutes; and
(c) separating the defatted solids from the ethanol to collect a defatted solids fraction;
wherein the defatted solids fraction contains greater than 90% protein and less than 2% lipid.

2. The method of claim 1 wherein the step of admixing the whey protein agglomerates with ethanol comprises admixing the whey protein agglomerates into a container comprising ethanol.

3. The method of claim 1 wherein the step of admixing the whey protein agglomerates with ethanol comprises submerging whey protein agglomerates in ethanol in the first stage of a series of extraction stages, the whey protein agglomerates being continuously submerged in ethanol through the series of extraction stages.

4. The method of claim 1 wherein the ethanol is heated to a temperature of from about 100° F. to about 135° F.

5. The method of claim 1 wherein the whey protein concentrate is selected from the group consisting of whey protein concentrate, denatured whey protein concentrate, evaporated whey protein concentrate, high fat whey protein concentrate, and combinations thereof.

6. A method for isolating from high-fat whey protein concentrate a fraction comprising milk fat globule membrane, the method comprising the steps of:
(a) agglomerating particles of whey protein concentrate to produce whey protein agglomerates that readily submerge when admixed with ethanol;
(b) admixing the whey protein agglomerates with ethanol, in the absence of acetic acid and citric acid, in a ratio of from about 1:3 to about 1:5 to immerse the whey protein agglomerates in ethanol for period of at least about 30 minutes;
(c) separating the defatted solids from the ethanol; and
(d) collecting the ethanol/fat micella containing the milk fat globule membrane.

7. A method for removing lactose from high-fat whey protein concentrate, the method comprising the steps of:
(a) agglomerating particles of whey protein concentrate to produce whey protein agglomerates that readily submerge when admixed with ethanol;
(b) admixing the whey protein agglomerates with ethanol, in the absence of acetic acid and citric acid, in a ratio of from about 1:3 to about 1:5 to immerse the whey protein agglomerates in ethanol for a period of at least about 30 minutes; and
(c) separating and collecting the defatted solids from the ethanol, the lactose remaining with the ethanol solvent.

8. A method for producing whey protein isolate from whey protein concentrate, the method comprising the steps of
(a) agglomerating particles of whey protein concentrate to produce whey protein agglomerates that readily submerge when admixed with ethanol;
(b) admixing the whey protein agglomerates with ethanol in a ratio of from about 1:3 to about 1:5 to immerse the whey protein agglomerates in ethanol for a period of at least about 30 minutes; and
(c) separating the defatted solids from the ethanol to collect a defatted solids fraction comprising whey protein isolate;
wherein the defatted solids fraction comprising whey protein isolate contains greater than 90% protein and less than 2% lipid.

9. The method of claim 8 wherein the step of admixing the whey protein agglomerates with ethanol comprises admixing the whey protein particles into a container comprising ethanol.

10. The method of claim 8 wherein the step of admixing the whey protein agglomerates with ethanol comprises submerging whey protein agglomerates in ethanol in the first stage of a series of extraction stages, the whey protein agglomerates being continuously submerged in ethanol through the series of extraction stages.

11. The method of claim 8 wherein the ethanol is heated to a temperature of from about 100° F. to about 135° F.

12. The method of claim 8 wherein the whey protein concentrate is selected from the group consisting of whey protein concentrate, denatured whey protein concentrate, evaporated whey protein concentrate, high fat whey protein concentrate, and combinations thereof.

13. The method of claim 1, wherein the step of admixing the whey protein agglomerates with ethanol takes place in the absence of acetic acid and citric acid.

14. The method of claim 6, wherein the defatted solids contain greater than 90% protein and less than 2% lipid.

15. The method of claim 7, wherein the defatted solids contain greater than 90% protein and less than 2% lipid.

16. The method of claim 8, wherein the step of admixing the whey protein agglomerates with ethanol takes place in the absence of acetic acid and citric acid.
